(19) United States
(12) Patent Application Publication
(10) Pub. No.: US 2007/0200722 A1
(43) Pub. Date: Aug. 30, 2007

(54) Belt pack accessory for machine condition monitoring

(75) Inventors: Richard W. Piety, Knoxville, TN (US); Thomas E. Nelson, Knoxville, TN (US)

Correspondence Address: LUEDEKA, NEELY & GRAHAM, P.C., P O BOX 1871, KNOXVILLE, TN, 37901, US

(73) Assignee: CSI Technology, Inc.

(21) Appl. No.: 11/363,473

(22) Filed: Feb. 27, 2006

(51) Int. Cl. G08B 21/00

(52) U.S. Cl. 340/679

(57) ABSTRACT

A system for diagnosing the operational health of machinery. A portable data processor is provided to acquire a machinery data signal from a diagnostic sensor configured to monitor machinery. The machinery data signal preferably includes vibration data, and may also include RFID tag information, temperature data, flux data, and other data related to machine health. The connection between the diagnostic sensor and the portable data processor is preferably a wired connection. The portable data processor analyzes the machinery data signal and produces a condition indicator that is used to activate an indicator in an arrangement that corresponds to the condition indicator. The portable data processor also transmits machine diagnostic information, preferably including the condition indicator, as a condition signal to a separately-housed portable data processor for further processing or storage. Preferably a limited range wireless communication link is provided for the transmission of the condition signal from the portable data processor to the portable data platform.

This application is related to U.S. patent application Ser. No. ______, “Combined Machine Identification and Diagnosis Device” by Piety and Nelson, filed concurrently herewith and incorporated in its entirety by reference.

### FIELD

This invention relates to the field of inspection equipment. More particularly, this invention relates to equipment for assessing the operational health of machinery as the machinery operates.

### BACKGROUND

Various systems have been created to diagnose the operating condition of machinery such as motors, pumps, valves, transmissions, compressors, and the like. Some of these systems analyze vibrations generated by the machinery in various spectral regimes including audible and ultrasonic frequencies. Many of these systems require extensive operator training in order to achieve accurate results. These systems are disadvantageous in that they do not provide a convenient way to store brief diagnostic results from multiple machines or multiple results over time from the same machine. Some systems also disadvantageously accumulate massive amounts of diagnostic data, much of which is irrelevant to the basic question of whether the machinery is operating satisfactorily, or is in need of preventive maintenance, or has failed. What is needed therefore is an easy-to-use system that provides such features as a simple indication of machinery health and storage of diagnostic results, and does not accumulate massive amounts of irrelevant test data.

### SUMMARY

The present invention provides a system for inspecting machinery. The system includes a diagnostic sensor for generating a machinery data signal for the machinery to be inspected. A limited-range diagnostic sensor communication link is provided for communicating the machinery data signal from the diagnostic sensor. the system includes a portable data processor comprising a visual indicator, housed in a first enclosure. The portable data processor is provided for receiving the machinery data signal from the diagnostic sensor over the limited-range diagnostic sensor communication link, and for using the machinery data signal to derive processed data comprising a condition indicator. The portable data processor is further configured to activate the visual indicator in an arrangement corresponding to the condition indicator. The system also includes a limited-range data communication link for transmitting at least a portion of the processed data from the portable data processor as a condition signal. The system further includes a portable data platform housed in a second enclosure physically separate from the first enclosure. The portable data platform is configured for receiving the condition signal from the portable data processor over the limited range data communication link and for deriving reported data corresponding to one or more operating conditions of the inspected machinery.

An alternative embodiment provides a system for inspecting machinery that includes a portable data processor housed in a first enclosure. The portable data processor has a field network interface. A machinery data signal is propagated through the field network interface into the portable data processor. The system includes a first microprocessor in the portable data processor for receiving and analyzing the machinery data signal and for producing processed data. The system further includes a portable data platform housed in a second enclosure. A condition signal incorporating at least a portion of the processed data is provided and the condition signal is propagated from the portable data processor to the portable data platform. There is a second microprocessor in the portable data platform for receiving the condition signal, extracting at least a portion of the processed data, and storing at least a portion of the processed data in a memory as reported data that corresponds to one or more operating conditions of the inspected machinery.

A method is provided for analyzing the health of a machine. The method includes a step of generating in a first portable electronic device a plurality of measurements for analyzing the health of the machine. A further step uses at least one of the generated measurements in the first portable electronic device to provide a condition indicator corresponding to the health of the machine. The method continues with activating a machine health indicator in the first portable electronic device in a configuration corresponding to the condition indicator. Then a condition signal incorporating the condition indicator is generated. The method proceeds with transmitting the condition signal to a co-located separately-housed second portable electronic device, and concludes with extracting the condition indicator from the condition signal and storing the at condition indicator in the second portable electronic device.

### BRIEF DESCRIPTION OF THE DRAWINGS

Further advantages of the invention may be apparent by reference to the detailed description in conjunction with the figures, wherein elements are not to scale so as to more clearly show the details, wherein like reference numbers indicate like elements throughout the several views, and wherein:

FIG. 1 is a pictorial illustration of an application of a system for diagnosing the health of a machine according to a preferred embodiment.

FIG. 2 is a pictorial illustration of a portable data processor according to a preferred embodiment.

FIG. 3 is a pictorial illustration of a portable data platform according to a preferred embodiment.

FIG. 4 is a block diagram of one preferred embodiment of a portable data processor.

FIG. 5 is a block diagram of one preferred embodiment of a portable data platform.

FIG. 6 is a block diagram of a further embodiment of a portable data processor.

FIG. 7 is a flow chart of a preferred method for diagnosing machine health.

### DETAILED DESCRIPTION

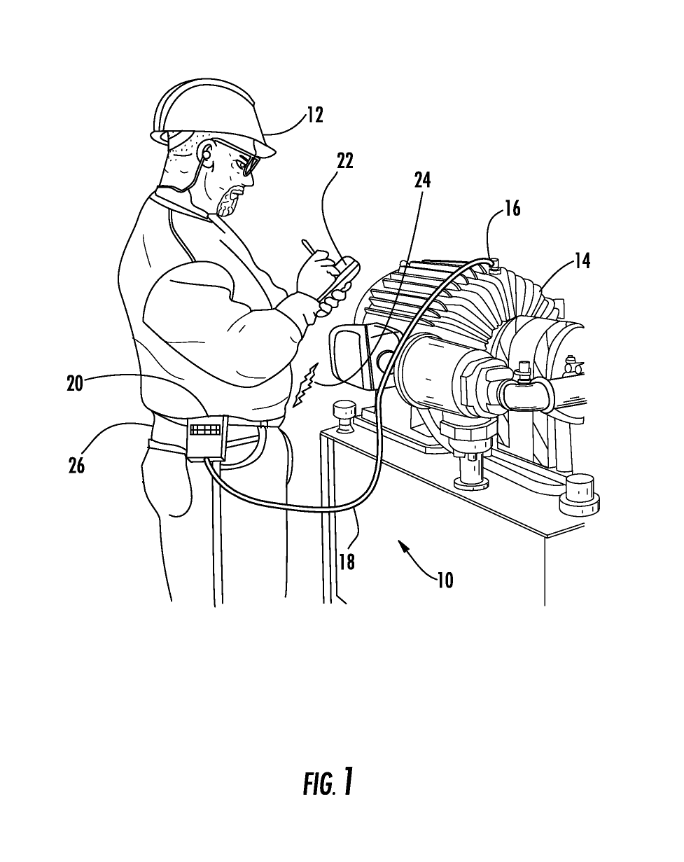

FIG. 1 illustrates one embodiment of a preferred diagnostic system 10 for inspecting the health of machinery, which in this example is being used by an inspector 12 to inspect a motor 14. Diagnostic system 10 preferably includes a diagnostic reader 16 linked by a diagnostic reader communication link 18 to a portable data processor 20. Preferably the diagnostic reader communication link 18 has a limited range of communication. One benefit of a limited range of communication is that it minimizes attenuation of the signal from the diagnostic reader 16 to the portable data processor 20.

In the embodiment of FIG. 1, the diagnostic reader communication link 18 includes a wired cable connection. Preferably the maximum length of the wired diagnostic reader communication link 18 is less than about fifty feet, but in some cases it may preferably have a length of about thirty feet, or about ten feet or less. Any wired communication link having a maximum cable length of up to approximately fifty feet, including extensions running through couplers, splitters, switches and so forth, is considered to be a limited range communication link. In alternative embodiments the diagnostic reader communication link 18 may be a wireless link. Examples of such a wireless links are wireless connections available from the Bluetooth Special Interest Group under the trademark Bluetooth. The Bluetooth wireless connection specification defines a range of approximately 30 feet. Other standard and non-standard wireless communication links may be used. Any wireless communication link having a maximum specified range of up to approximately fifty feet, including all near-real-time communication relays, is considered to be a limited range communication link. However, it will be understood that the diagnostic reader communication link 18 need not be a limited range communication link.

The portable data processor 20 is shown in FIG. 1 configured to communicate with a portable data platform 22 through a data communication link 24. Data communication link 24 is generally used by the operator 12 to operate and control the portable data processor 20. Preferably, the data communication link 24 has a limited range of communication. One benefit of a limited range of communication in data communication link 24 is that it avoids interference from other communication links that may be operating in the same general vicinity. In the embodiment of FIG. 1, the data communication link 24 includes a wireless communication connection. Preferably the maximum range of the wireless data communication link 24 is less than about fifty feet and it may be less than that if, for example, the data communication link 24 is provided by a Bluetooth wireless connection which, as previously noted, has a range of approximately 30 feet.

In the most preferred embodiments, the portable data processor 20 and the portable data platform 22 are, as shown in FIG. 1, housed in physically separate enclosures. The term “physically separate” enclosures refers to enclosures that have no structural connection, except in embodiments where the data communication link 24 comprises a wired cable connection. In such embodiments portable data processor 20 and portable data platform 22 are physically connected solely by the wired cable connection. One advantage of having physically separate enclosures is that the portable data processor 20 and the portable data platform 22 may be independently powered. This is an advantage, for example, in embodiments where a commercial personal digital assistant (PDA) device is adapted for use as the portable data platform 22. Typically the electrical power resources of a PDA are quite limited. By physically separating and separately powering the portable data processor 20 from the portable data platform 22, the portable data processor 20 will not drain the battery of the portable data platform 22. Also separating these systems distributes the weight of the power source (e.g., batteries) for easier carrying.

A further advantage of having a portable data processor and a portable data platform in separate enclosures is that it facilitates compliance with government standards on intrinsic safety because power consumption is dispersed and equipment operating temperatures may be lower. Examples of government intrinsic safety standards are the European Union's ATEX regulations and various sections of 29 CFR in the United States.

Yet another advantage of separate enclosures is that it enhances design flexibility. For example, either the portable data platform 22 or the portable data processor 20 may be independently upgraded in form factor, firmware, operating system, or application software. In other words, as long as the connectivity standard is maintained the hardware of either portable data platform 22 or the portable data processor 20 may be modified to accommodate new adapters (PC Card, Compact Flash (CF), Secure Digital (SD), etc.) that may enhance performance. Another advantage of having physically separate enclosures is that the size of the instrument held in the hands of the operator 12 may be minimized by attaching the portable data processor 20 to a belt 26 of the operator 12 as shown in FIG. 1. This means that the operator has both hands free to use the portable data platform 22.

Preferably the connection between the portable data processor 20 and the belt 26 is provided by a permanent magnet on the portable data processor 20 to removably attach the portable data processor 20 to the belt 26. In such configurations the portable data processor 20 may be magnetically attached to a ferrous or similar metal component on or near the machinery being inspected and the operator may step away to a more convenient, safer, or comfortable location while conducting the inspection. When the inspection is complete the operator removes the diagnostic reader 16 from the machinery being inspected, and removes the portable data processor 20 from the machinery and re-affixes the portable data processor 20 to his belt using the magnetic attachment. It is convenient to also have mechanism to attach the diagnostic reader 16 to the operator's belt 26 or to the portable data processor 20 itself. Such mechanisms may include a pouch, a hook-and-loop fabric fastener, or may utilize the magnet on the portable data processor 20.

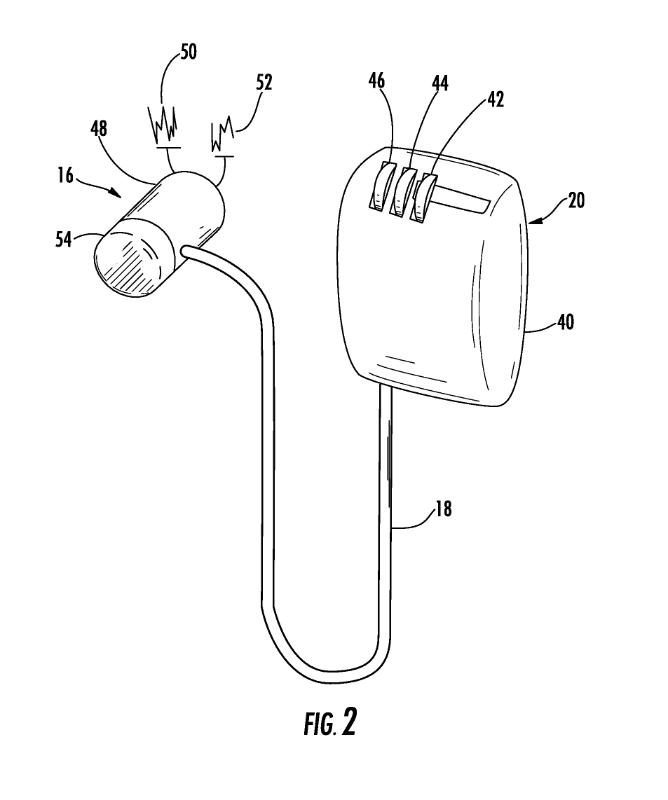

FIG. 2 illustrates further details of the portable data processor 20, the diagnostic reader 16, and the diagnostic reader communication link 18. The portable data processor 20 is seen to have an enclosure 40. In preferred embodiments, one or more visual indicators, such as a red indicator light 42, a yellow indicator light 44, and a green indicator light 46 are mounted in the enclosure 40. The red 42, yellow 44, and green 46 indicator lights are an example of a red/yellow/green indicator. Another example of a red/yellow/green indicator is an area of a display screen that may be changed between such descriptive words or indicia such as “good,” “marginal,” and “bad.” In some embodiments no visual indicator is provided on the portable data processor 20; the only visual indicator is provided on the portable data platform 22.

As depicted in FIG. 2, the diagnostic reader 16 is seen in this embodiment to have a vibration sensor 48 capable of detecting a plurality of vibration spectra, for example first vibration spectrum 50 and second vibration spectrum 52. Vibration sensor 48 is an example of a “diagnostic sensor.” In an optional but preferred embodiment, the diagnostic reader 16 includes an RFID-like Radio Frequency Information System (RFIS) communicator 54. An item of machinery being inspected (e.g., motor 14 of FIG. 1) may bear an RFID-like tag that stores the identity (e.g., serial number, property item number, etc.) of that item of machinery. RFIS communicator 54 may then be used to read the RFIS tag and automatically identify an item of equipment being inspected. As used herein the term “RFIS” encompasses both “standard” RFID communication systems (that conform to national or international standards) as well as vendor-proprietary RFID systems. While most present-day RFID readers and transponders use either inductive coupling or propagation coupling for communication, as used herein the term “RFIS” in association with readers and transponders encompasses such RFID readers and transponders, and it also encompasses radio frequency readers and transponders that employ other electronic coupling mechanisms such as capacitive coupling. While most present-day RFID transponders use silicon-based microcircuits for information storage, as used herein the term “RFIS” in association with transponders encompasses such RFID transponders and it also encompasses more exotic radio frequency transponder data storage systems such as surface acoustic wave tags that use a lithium niobate crystal in place of a silicon chip. While most present-day RFID readers, writers, and transponders communicate at a specific frequency and protocol to read, write, or acquire static data, as used herein the term “RFIS” in association with readers, writers, and transponders encompasses such RFID readers, writers, and transponders and it also encompasses “smart” radio frequency readers, writers and transponders that dynamically adapt their frequencies and protocols to exchange information.

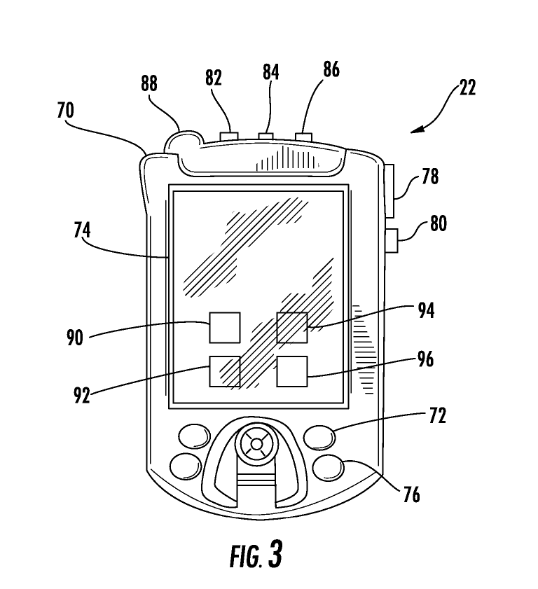

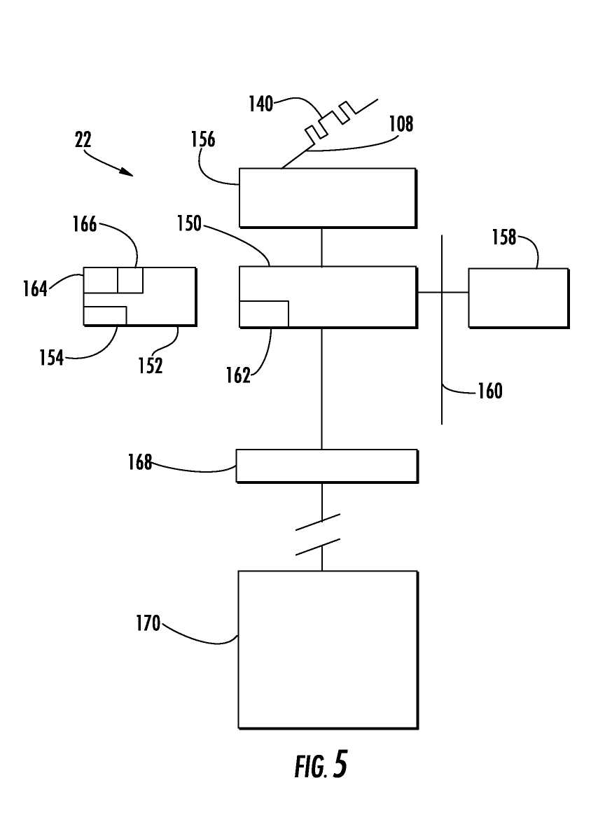

FIG. 3 illustrates further details of the portable data platform 22 according to this embodiment. Portable data platform 22 has an enclosure 70 that preferably includes a power switch 72, a display 74, control buttons 76, an accessory input connector 78, an accessory output connector 80, a network connector 82, and a USB connector 84. Most preferably, the portable data platform 22 includes at least one wireless communication interface 86 for a communication link with a portable data processor 20. Some embodiments also include a Wi-Fi wireless interface 88. Wi-Fi wireless interface 88 may be used to permit the portable data platform 22 to communicate with a base station, as further described later herein with respect to FIG. 5. The display 74 may include access to program setup software 90, inspection route information 92, application software 94, and data storage 96.

In many applications the health of a machine is assessed by measuring the health of a component of the machine. For example, the health of a motor may be determined by assessing the health of a particularly vulnerable bearing. In some embodiments one portable data processor 20 may be sequentially connected to different components (such as two different bearings) of a machine and the resulting data analyzed by the portable data platform 22 in order to arrive at an overall indication of machine health. In some embodiments several different portable data processors 20, perhaps containing different sensing elements, may be connected sequentially or simultaneously to one portable data platform 22. Data taken sequentially from several different portable data processors 20, or data taken from several different portable data processors 20 connected simultaneously to one portable data platform 22, may be combined by the portable data platform 22 to arrive at an overall indication of machine health. As used herein any of these alternative configurations and methods represents configurations and methods for assessing the health of machinery.

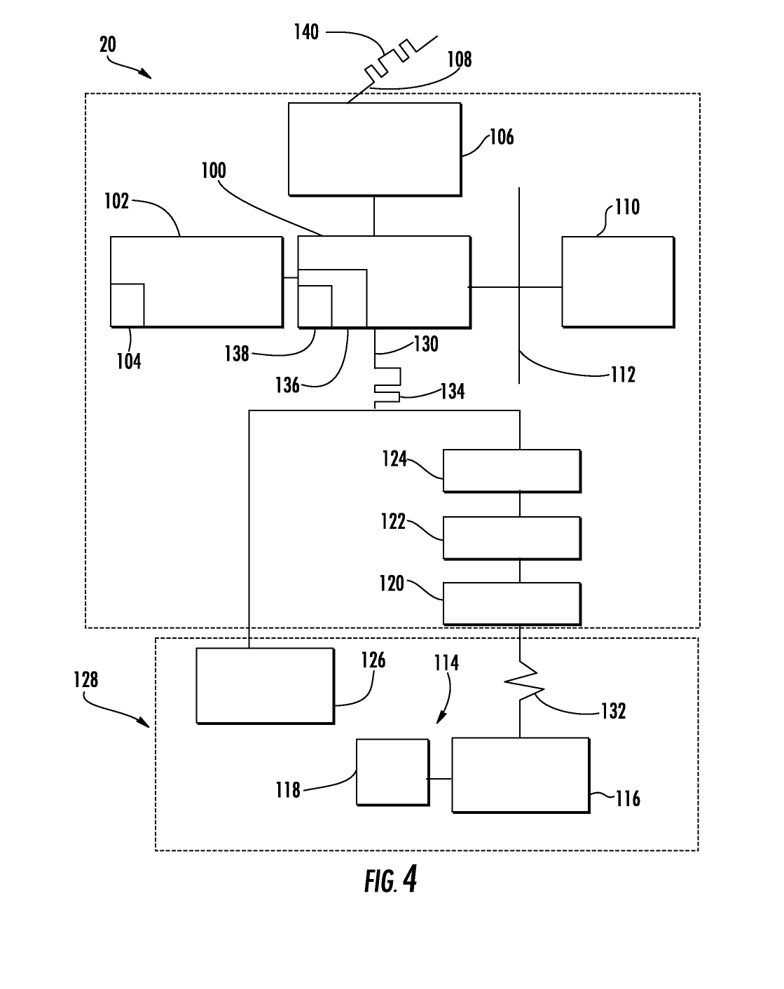

FIG. 4 further illustrates certain elements of a diagnostic system for inspecting machinery according to one embodiment. A portable data processor 20 preferably includes a microprocessor 100 and memory 102. Typically, the microprocessor 100 includes an electronic calendar and a time-of-day clock. Application software 104 may be downloaded from the memory 102 and run on the microprocessor 100. The microprocessor 100 is connected to an RF interface 106 that utilizes a data communication link 108. Batteries/Power Supply 110 provide power to certain elements through a power bus 112. A diagnostic sensor 114 is provided. Preferably, diagnostic sensor 114 includes an accelerometer 116 as the sensing device, and an accelerometer power supply 118. In alternative embodiments diagnostic sensor 114 may comprise other sensing devices, such as a thermocouple for measuring temperature, a tachometer for measuring revolution speed, a Hall-effect sensor to measure motor flux, or other sensor to measure a parameter indicative of machinery health. In some embodiments multiple sensing devices may be incorporated into diagnostic sensor 114. A gain adjust and anti-alias filter 120, an A/D converter 122 (preferably a 24-bit A/D converter), and a diagnostic sensor controller 124 are provided in portable data processor 20. In some embodiments the gain adjust the anti-alias filter 120 and/or the A/D converter 122 and/or the diagnostic sensor controller 124 may be incorporated into the diagnostic reader/128 instead of the portable data processor 20.

As previously indicated, preferred embodiments incorporate a radio frequency information system (RFIS) communicator 126 to capture machine configuration information. In embodiments where an RFIS communicator 126 is employed in combination with a diagnostic sensor 114, the combination of the RFIS communicator 126 and the diagnostic sensor 114 is diagnostic reader 128. Diagnostic reader 128 and its preferable component elements (diagnostic sensor 114 and RFIS communicator 126) are in operative communication with portable data processor 20 at least in part via diagnostic reader communication link 130. It shall be understood that the term “in operative communication” refers to direct or indirect communication of data between a first and a second hardware element either directly or through one or more intervening elements. Diagnostic reader communication link 130 is used by the microprocessor 100 to control the operation of the diagnostic sensor 114 and the RFIS communicator 126. In embodiments that do not incorporate an RFIS communicator 126, the diagnostic reader communication link 130 is a “diagnostic sensor communication link.”

In operation, a diagnostic sensor signal 132 is generated by accelerometer 116. Preferably diagnostic sensor signal is an analog signal. In embodiments where diagnostic sensor signal 132 is an analog signal, diagnostic sensor signal 132 may be pre-processed, as by the gain adjust and anti-alias filter 120 and then passed through the A/D converter 122 and the diagnostic sensor controller 124 to create a machinery data signal 134. Machinery data signal 134 preferably comprises a digital signal, but in some embodiments machinery data signal 134 may comprise an analog signal. Machinery data signal 134 is transmitted to the microprocessor 100 when the microprocessor 100 directs the diagnostic sensor controller 124 to transmit the machinery data signal 134 to the microprocessor 100. In embodiments where an RFIS communicator 126 is employed, the machinery data signal 134 may comprise machine configuration information acquired by the RFIS communicator 126 that is transmitted to the microprocessor 100 when the microprocessor 100 directs the RFIS communicator 126 to acquire the machine configuration information.

Machinery data signal 134 is transmitted to the microprocessor 100 for analysis. Microprocessor 100 generates processed data 136 from the machinery data signal 134. Processed data 136 are digital data, and processed data 136 may include a condition indicator 138. In some diagnostic systems the condition indicator 138 may include a data set having several scalar values indicative of one or more diagnostic measures of the health of the machinery being inspected. Scalar values are useful for tracking trends of machinery health. In diagnostic systems designed for unsophisticated users, the condition indicator 138 may be a simple good/bad/marginal flag that may then be used by the microprocessor 100 to activate a machine health indicator in a corresponding arrangement, such as by turning on either the green indicator light (46 in FIG. 2) if the condition indicator is “good,” or turning on the red indicator light (42 in FIG. 2) if the condition indicator is “bad,” or turning on the yellow indicator light (44 in FIG. 2) if the condition indicator is “marginal.”

In the most preferred embodiments at least a portion of the processed data 136 (FIG. 4) is incorporated by the microprocessor 100 into a condition signal 140 that is transmitted over the data communication link 108. Preferably condition signal 140 comprises a digital signal. Data communication link 108 typically includes all of the basic layers of a communication protocol, including physical, data transport, network and application layers. Processed data 136 that are incorporated into the condition signal 140 form a portion of the application layer of the data communication link 108. Preferably, at least the condition indicator 138 portion of the processed data 136 is incorporated into the condition signal 140. In some embodiments additional portions of the processed data 136 may be sent by the portable data processor 20 to the portable data platform 22 (FIG. 3) over the data communication link 108.

FIG. 5 illustrates certain elements of the portable data platform 22 according to an embodiment of the invention. The portable data platform 22 includes a microprocessor 150 and memory 152. Typically the microprocessor 150 includes an electronic calendar and a time-of-day clock. Application software 154 may be downloaded from the memory 152 and run on the microprocessor 150. The microprocessor 150 is connected to an RF interface 156 that utilizes the data communication link 108 depicted in FIG. 4. Batteries/power supply 158 provide electrical power to various elements of the portable data platform 22 over a power bus 160. In the embodiment depicted, the condition signal 140 (incorporating at least a portion of the processed data 136 from FIG. 4) is received over the data communication link 108 by the microprocessor 150 through the RF interface 156.

In the most preferred embodiments at least a portion of the processed data (136, FIG. 4) sent by the portable data processor 20 to the portable data platform 22 is extracted from the condition signal 140 and used by microprocessor 150 to generate reported data 162. The reported data 162 preferably includes the identity of the machine being tested, the date and time of the test as well as at least a portion of the processed data (136 in FIG. 4) (and preferably at least a portion of the condition indicator 138) received from the portable data processor (20 in FIG. 4). Some or all of the reported data 162 may be stored by the microprocessor 150 in memory 152 as historical data 164 for future retrieval. In preferred embodiments the application software 154 in the portable data platform 22 compares at least a portion of the condition indicator 138 with historical data 164 to generate a trend analysis 166. Some embodiments may incorporate a network interface 168 in the portable data platform 22. Network interface 168 may be a wireless (e.g., Wi-Fi) link, or a wired interface. The network interface 168 may be used to download all or a portion of the reported data 162 to a base station 170. Network interface 168 may be a connection to a local area network or may be a connection through a dedicated communication link between the portable data platform 22 and the base station 170.

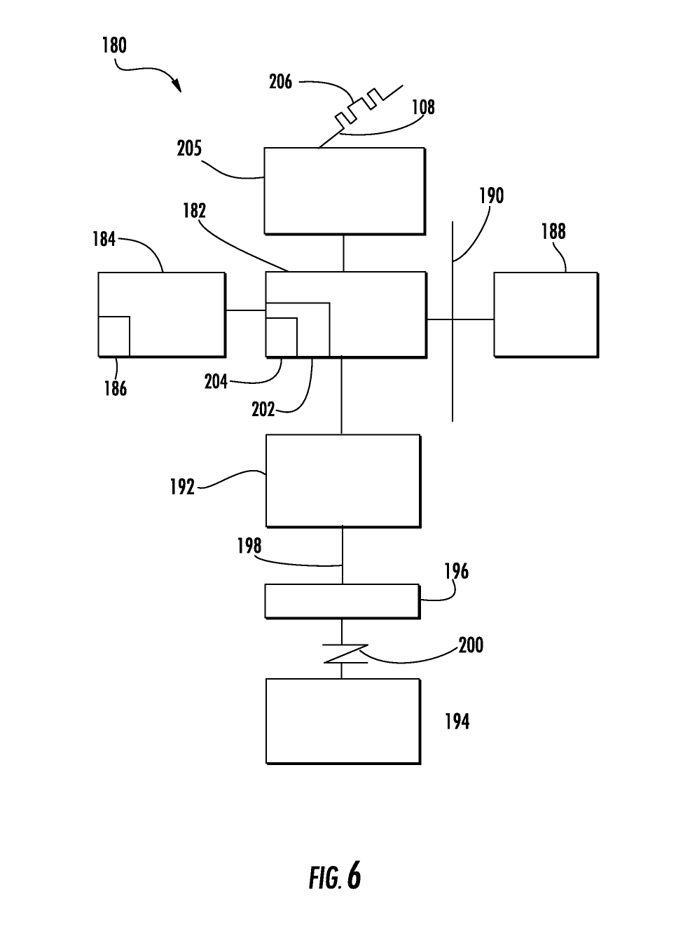

FIG. 6 illustrates another embodiment of a portable data processor, portable data processor 180. The portable data processor 180 preferably includes a microprocessor 182 connected to a memory 184. Typically the portable data processor 180 includes an electronic calendar and a time-of-day clock. Application software 186 may be downloaded from the memory 184 and run on the microprocessor 182. Batteries/Power Supply 188 provide electrical power to various elements of the portable data processor 180 through a power bus 190. The portable data processor 180 has a field network interface 192. The field network interface 192 may be configured for interfacing to a field network 194, such as a Highway Addressable Remote Transducer (HART) network, a Foundation Fieldbus network, or a similar network, through a connector 196. Typically the interface to the field network interface 192 through a cable 198 from the connector 196 is a simple twisted pair of wires. Here the term “twisted pair” is used broadly to include such variations as two parallel wires in ribbon cable and a coaxial pair of conductors, as well as two separate wires that are physically twisted together.

A machinery data signal 200 is sent from the field network 194 to the microprocessor 182 through the field network interface 192. The microprocessor 182 analyzes the machinery data signal 200 and produces processed data 202. Processed data 202 typically includes a condition indicator 204. Condition indicator 204 may be a good/bad/marginal indicator of machinery health, or condition indicator 204 may be a numerical scalar value providing a more quantitative diagnosis of machinery health. Preferably the microprocessor 182 uses the condition indicator 204 to at least in part generate a condition signal 206 that is transmitted using an RF Interface 205 over the data communication link 108 (previously described in the context of FIGS. 4 and 5). The condition indicator 204 is preferably then processed by a portable data platform (e.g., 22 in FIGS. 3, and 5) in a manner comparable to the description of the processing of the condition indicator 138 that was presented in the discussion of FIG. 5.

An advantage of the embodiment of the portable data processor 180 presented in FIG. 6 is that, by connecting to the field network 194, the machinery data signal 200 may contain data from several different machines. This permits the portable data processor 180 to assess the health of a plurality of machinery (i.e., several machines) from one location.

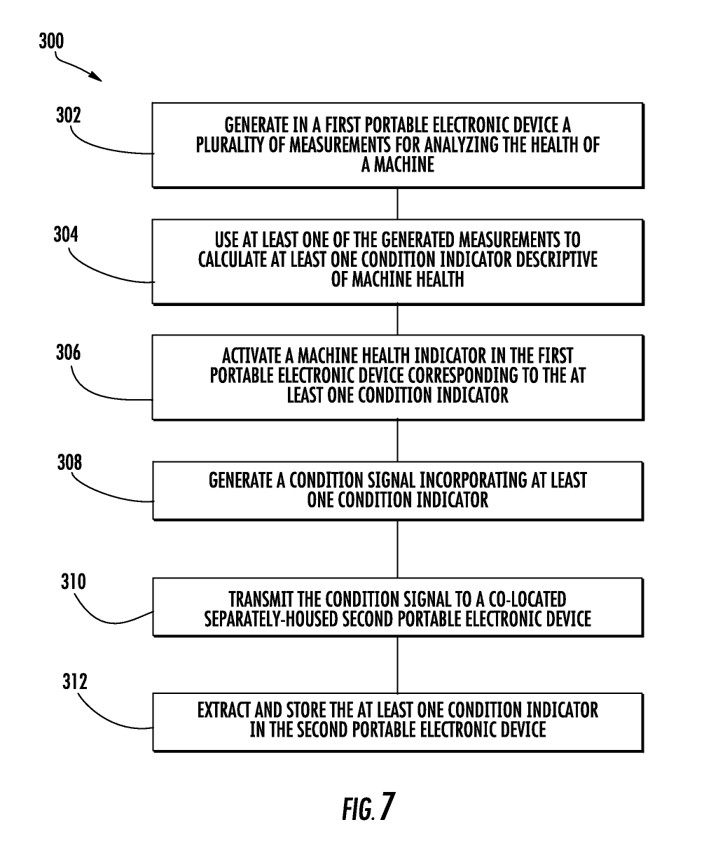

FIG. 7 illustrates a method embodiment, process 300. Process 300 begins with a step 302 in which a first portable electronic device is used to generate a plurality of measurements for analyzing the health of a machine. These measurements may represent such parameters as peak vibration frequencies, power consumption, oil pressure, temperature, motor flux. Two measurements of the same parameter constitute a plurality of measurements, as do single measurements of two different parameters. In embodiments where an RFIS communicator (e.g., 126 in FIG. 4) is used in combination with a diagnostic sensor (e.g. 126 in FIG. 4), the measurements may include machine configuration information. In a step 304, at least one generated measurement is used to produce at least one condition indicator representative of machine health. Examples of a condition indicator are (a) “Good,” (b) peak vibration at 2 Fₗᵢₙₑ=0.05 ips, and (c) Bearing Temperature=140° C.

In a step 306 a machine health indicator is activated corresponding to at least one condition indicator. For example, in embodiments where a peak vibration measurement is taken, and the measured value is peak vibration at 2 Fₗᵢₙₑ=0.05 ips, and the “good” operation range is 2 Fₗᵢₙₑ<0.100 ips, the machine health indicator activated may be a green indicator light. In embodiments where a peak vibration measurement and a bearing temperature are taken, and the measured value is peak vibration at 2 Fₗᵢₙₑ=0.05 ips and the bearing temperature is =140° C., and the “good” peak vibration range at 2 Fₗᵢₙₑ is <0.100 ips and the “good” bearing temperature is <120° C., the machine health indicator activated may be a yellow indicator light. In this latter example it will be understood that appropriate algorithms or lookup tables are programmed into the first portable electronic device to arrive at a single machine health indicator based upon a plurality of condition indicators.

In a step 308 a condition signal is generated incorporating at least one condition indicator. An example of a condition signal is a set of Bluetooth data packets that encode at least one condition indicator. In embodiments where an RFIS communicator (e.g., 126 in FIG. 4) is used in combination with a diagnostic sensor, a condition signal may also include other information such as the identity of the machine being tested, which may be based upon an RFID-like tag read by the diagnostic reader used to check the machinery. In a step 310 the condition signal is transmitted to a co-located separately-housed second portable electronic device. The term “co-located” refers to an operation where the second portable electronic device is within a limited range of communication. The term “separately-housed” refers to an operation where the first portable electronic device and the second portable electronic device are in separate enclosures. The advantages of these operational designs are discussed herein with respect to FIG. 1. In a step 312 the at least one condition indicator is extracted from the condition signal by the second portable electronic device and stored therein.

The foregoing descriptions of embodiments of this invention have been presented for purposes of illustration and exposition. They are not intended to be exhaustive or to limit the invention to the precise forms disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A system for inspecting machinery, the system comprising:
a diagnostic sensor for generating a machinery data signal for the machinery to be inspected;
a limited-range diagnostic sensor communication link for communicating the machinery data signal from the diagnostic sensor;
a portable data processor comprising a visual indicator, the portable data processor being housed in a first enclosure for receiving the machinery data signal from the diagnostic sensor over the limited-range diagnostic sensor communication link and for using the machinery data signal to derive processed data comprising a condition indicator and configured to activate the visual indicator in an arrangement corresponding to the condition indicator;
a limited-range data communication link for transmitting at least a portion of the processed data from the portable data processor as a condition signal; and
a portable data platform housed in a second enclosure physically separate from the first enclosure and configured for receiving the condition signal from the portable data processor over the limited range data communication link and for deriving reported data corresponding to one or more operating conditions of the inspected machinery.

2. The system of claim 1, wherein the limited-range diagnostic sensor communication link comprises a wire less than about fifty feet in length.

3. The system of claim 1, wherein the machinery data signal comprises a plurality of vibration spectra.

4. The system of claim 1, wherein the diagnostic sensor is combined with an RFIS communicator and the machinery data signal comprises equipment identification information from the RFIS communicator.

5. The system of claim 1, wherein the portable data processor comprises a microprocessor and the system further comprises a gain adjust and anti-alias filter configured to pre-process the machinery data signal before the machinery data signal is passed to the microprocessor.

6. The system of claim 1, wherein the visual indicator comprises a red/yellow/green indicator.

7. The system of claim 1, wherein the processed data comprises a scalar value indicative of the health of the inspected machinery.

8. The system of claim 1, further comprising application software in the portable data processor for storing reported data as historical data in a memory and for generating a trend analysis using the historical data and the process data element.

9. The system of claim 1, wherein the limited-range data communication link comprises a limited-range wireless link.

10. A system for inspecting machinery, the system comprising:
a portable data processor housed in a first enclosure, the portable data processor having a field network interface;
a machinery data signal propagated through the field network interface into the portable data processor;
a first microprocessor in the portable data processor for receiving and analyzing the machinery data signal and for producing processed data;
a portable data platform housed in a second enclosure;
a condition signal incorporating at least a portion of the processed data, the condition signal being propagated from the portable data processor to the portable data platform; and
a second microprocessor in the portable data platform for receiving the condition signal, extracting at least a portion of the processed data, and storing at least a portion of the processed data in a memory as reported data corresponding to one or more operating conditions of the inspected machinery.

11. The apparatus of claim 10, wherein the field network interface comprises a twisted pair of wires.

12. The apparatus of claim 10, wherein the condition signal is propagated wirelessly from the portable data processor to the portable data platform.

13. The apparatus of claim 10, wherein the field network interface comprises a HART interface.

14. The apparatus of claim 10, wherein the field network interface comprises a Foundation Fieldbus interface.

15. The apparatus of claim 10, wherein the portable data platform further comprises a network interface for downloading at least a portion of the reported data to a base station.

16. A method for analyzing the health of a machine, the method comprising:
(a) generating in a first portable electronic device a plurality of measurements for analyzing the health of the machine;
(b) using at least one of the generated measurements in the first portable electronic device to provide a condition indicator corresponding to the health of the machine,
(c) activating a machine health indicator in the first portable electronic device in a configuration corresponding to the condition indicator;
(d) generating a condition signal incorporating the condition indicator;
(e) transmitting the condition signal to a co-located separately-housed second portable electronic device; and
(f) extracting the condition indicator from the condition signal and storing the at condition indicator in the second portable electronic device.

17. The method of claim 16, wherein step (a) comprises generating a plurality of diagnostic sensor signals from at least one transducer associated with the machine and transmitting at least a portion of the generated diagnostic sensor signals to a first portable device, and generating in the first portable electronic device a plurality of measurements for analyzing the health of the machine from the at least portion of the diagnostic sensor signals transmitted to the first portable device.

18. The method of claim 16, wherein step (a) comprises generating in a first portable electronic device a plurality of vibration measurements for analyzing the health of the machine.

19. The method of claim 16, wherein step (b) comprises using at least two generated measurements to calculate at least one health scalar value indicative of machine health.

20. The method of claim 16, further comprising the step of transmitting at least a portion of the plurality of measurements for analyzing the health of the machine from the first portable electronic device to the co-located separately-housed second portable electronic device.

21. The method of claim 20, further comprising the step of downloading to a base station the at least a portion of the plurality of measurements for analyzing the health of the machine transmitted from the first portable electronic device to the co-located separately-housed second portable electronic device.
